(19) United States
(12) Patent Application Publication
(10) Pub. No.: US 2023/0075971 A1
(43) Pub. Date: Mar. 9, 2023

(54) DROPPED TRAFFIC REROUTING FOR ANALYSIS

(71) Applicant: Hewlett Packard Enterprise Development LP, Houston, TX (US)

(72) Inventors: Giuseppe Scaglione, Granite Bay, CA (US); Jonathan Michael Seely, Cool, CA (US)

(21) Appl. No.: 17/470,730

(22) Filed: Sep. 9, 2021

(51) Int. Cl. H04L 12/823; H04L 12/801; H04L 12/707

(52) U.S. Cl. CPC H04L 47/32; H04L 47/11; H04L 45/22

(57) ABSTRACT

One aspect of the instant application provides a system and method for rerouting dropped packets back to a switch for analysis. During operation, the system determines, by packet-forwarding hardware logic on the switch, a destination port associated with a received packet, and determines whether the destination port is congested. In response to determining that the destination port is congested, the system drops the received packet from the destination port and sends the dropped packet to an internal dropped-packet-rerouting port to reroute the dropped packet back to the packet-forwarding hardware logic. In response to the packet-forwarding hardware logic determining that a packet is a rerouted packet from the internal dropped-packet-rerouting port, the system forwards the rerouted packet to a packet-analyzing entity for analysis.

### BACKGROUND

This disclosure is generally related to processing and forwarding packets by a switch. More specifically, this disclosure is related to a system and method that reroute packets dropped by a switch back to the switch and forward such rerouted packets to a packet-analyzing destination for analysis.

### BRIEF DESCRIPTION OF THE FIGURES

FIG. 1 illustrates a switch architecture, according to one aspect of the application.

FIG. 2 illustrates a block diagram of a buffer-management-and-queuing system, according to one aspect of the application.

FIG. 3 illustrates a block diagram of a packet-forwarding logic block, according to one aspect of the application.

FIG. 4 presents a flowchart illustrating a process for configuring a switch to facilitate analysis of dropped packets, according to one aspect of the application.

FIG. 5 presents a flowchart illustrating operations for processing a packet by a switch, according to one aspect of the application.

FIG. 6 illustrates a computer system that facilitates processing of dropped packets, according to one aspect of the application.

In the figures, like reference numerals refer to the same figure elements.

### DETAILED DESCRIPTION

The following description is presented to enable any person skilled in the art to make and use the examples and is provided in the context of a particular application and its requirements. Various modifications to the disclosed examples will be readily apparent to those skilled in the art, and the general principles defined herein may be applied to other examples and applications without departing from the spirit and scope of the present disclosure. Thus, the scope of the present disclosure is not limited to the examples shown but is to be accorded the widest scope consistent with the principles and features disclosed herein.

Due to latency and bandwidth constraints, packets arriving at a switch are typically buffered before they are transmitted to their destinations. More particularly, for a switch implementing the virtual output queue (VOQ) architecture, packets directed to a particular egress port can be queued at a dedicated queue for that particular egress port. If an egress port is congested (e.g., the queue is saturated), packets directed to that egress port will be dropped, although these packets are not intended to be dropped. In an existing switch, these dropped packets are counted without the opportunity to perform further analysis on these packets (e.g., determining the size, type, source, or destination of a dropped packet). To solve this problem, this disclosure provides a switch that includes an internal port that can reroute the dropped packets back to the switch to allow the packet-forwarding logic to forward the dropped packets to a packet-processing destination, which can be the switch CPU or an external node having network-analyzing capability, for analysis.

In existing switches, when a packet is dropped, a counter value is incremented. However, packets can be dropped for various reasons. For example, certain packets can be dropped due to packet-forwarding rules, and certain packets can be dropped due to oversubscription of the egress path (i.e., the destination port is out of queuing memory). In existing switches, there is no dedicated counter to count the number of packets that are dropped due to the out-of-memory situation at the destination port. Moreover, existing switches lack the mechanism for analyzing the dropped packets. In other words, the switch does not collect information (e.g., size, type, source, or destination) associated with the dropped packets. Such information can be important to network administrators. For example, if the network administrator is notified that a large number of dropped packets are from a certain source, the network administrator may throttle the transmission rate of the source or even block the source; or if the network administrator is notified that a large number of dropped packets are destined to a certain destination, the network administrator may allocate more resources (e.g., bandwidth or buffer space) to the destination port.

According to one aspect of this application, upon determining that a packet needs to be dropped due to congestion at the egress port, instead of discarding the packet (e.g., ejecting the packet from the switch), such a packet (which is referred to as a “dropped packet” in this disclosure) can be forwarded to the internal port. Note that although this packet is not yet dropped out of the switch, it is still referred to as a “dropped packet,” because the buffer-management-and-queuing logic has determined that the packet cannot be forwarded to its destination port. From the point of view of the packet destination, the packet is considered a dropped packet.

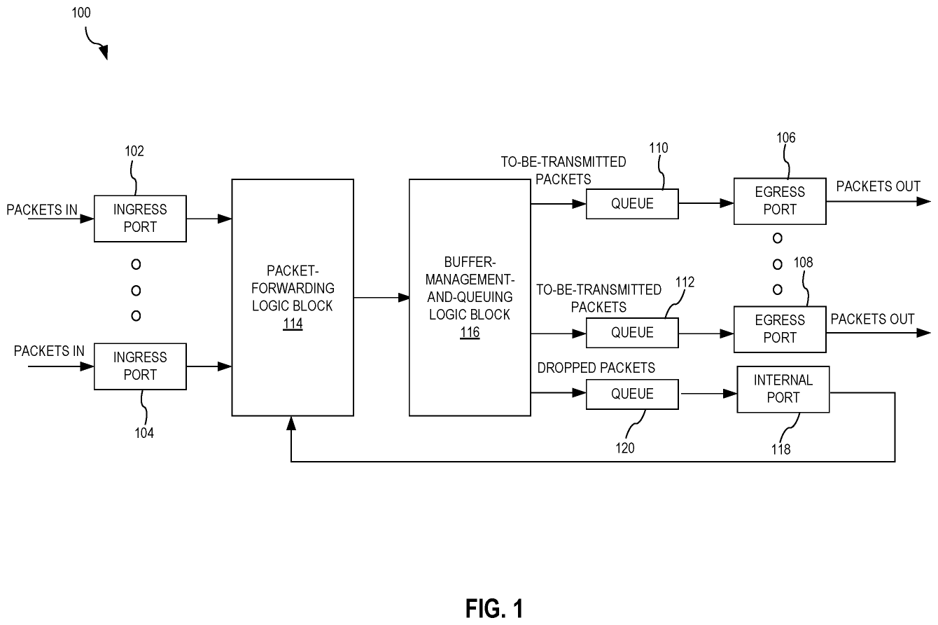

FIG. 1 illustrates a switch architecture, according to one aspect of the application. In FIG. 1, switch 100 includes a number of ingress ports (e.g., ports 102 and 104), a number of egress ports (ports 106 and 108) and their corresponding queues (queues 110 and 112), a packet-forwarding logic block 114, a buffer-management-and queuing logic block 116, and an internal port 118 and its queue 120.

The ingress ports receive packets from connected devices (e.g., computers, access points, other switches, etc.), and the egress ports transmit packets to connected devices. In this example, it is assumed that switch 100 implements the virtual output queue (VOQ) architecture where each egress port has dedicated queues. In FIG. 1, it is shown that each egress port has one queue. In practice, each egress port can include multiple queues (e.g., multiple priority queues with a priority queue for each priority class).

Packet-forwarding logic block 114 can maintain one or more forwarding tables, such as layer 2 (L2) and layer 3 (L3) tables and rule tables that implement a predetermined set of packet-forwarding rules or policies. Based on the forwarding tables, packet-forwarding logic block 114 can determine whether a received packet should be dropped, forwarded to an egress port, or replicated to multiple egress ports.

Buffer-management-and-queuing logic block 116 can organize and regulate access to oversubscribed resources (e.g., the egress ports). For example, if switch 100 receives 100 packets in 1 μs but can only output 50 packets in the 1 μs period, then 50% of the received packets need to be buffered (e.g., in a shared buffer) and queued (e.g., in queues of the corresponding egress ports), until the remaining packets can be processed and outputted by switch 100. The size of the buffer is limited and continued oversubscription will ultimately lead to packet drops due to the buffer filling up. Note that not all packets are treated the same. The order in which buffered packets are organized for service can vary depending on the architecture, but it is generally determined by a certain fixed set of attributes, such as the packet's source address, the packet's destination address, the priority classification of the packet, etc. For example, if two packets with different priority classifications are competing for the same buffer resource, the packet with a lower priority will be dropped while the packet with a higher priority will be accepted to the buffer. For simplicity of illustration and description, in this disclosure, each egress port is shown to be associated with one queue for queuing packets. For example, packets destined to egress port 106 can be queued in queue 110, and packets destined to egress port 108 can be queued in queue 112. In practice, each egress port can have a set of queues.

When packet-forwarding logic block 114 determines that a received packet should be forwarded to a particular egress port, buffer-management-and-queuing logic block 116 can send the packet to the egress port and the packet will be temporarily stored in a queue corresponding to the egress port before it is transmitted out of the egress port. However, if the destination queue of the received packet is saturated (e.g., it is full or its utilization is greater than a predetermined threshold value), buffer-management-and-queuing logic block 116 needs to drop the packet (e.g., based on preconfigured criteria, usually via quality of service rules). In one example, ingress ports 102 and 104 each receive traffic at a rate of 1 Gbps, and all traffic is destined to egress port 106, which is capable of transmitting traffic at a rate of 1 Gbps. This means that egress port 106 is oversubscribed in a 2:1 ratio, and the excessive incoming traffic can quickly fill up queue 110, causing buffer-management-and-queuing logic block 116 to drop packets at a rate of 1 Gbps. Note that these packets are not intended to be dropped by the packet-forwarding rules, but are dropped because the destination port is out of queuing memory.

In one example, upon determining that a packet needs to be dropped because the destination port is out of queuing memory, buffer-management-and-queuing logic block 116 can forward the packet to internal port 118. Internal port 118 can be a port that is not visible to devices external to switch 100. In one example, internal port 118 can be a dedicated port only visible to buffer-management-and-queuing logic block 116. In an alternative example, internal port 118 can be implemented by repurposing a custom physical port. More specifically, internal can be configured to only forward traffic back to packet-forwarding logic block 114. When the dropped packets are forwarded by buffer-management-and-queuing logic block 116 to internal port 118, these dropped packets can be queued in queue 120. The depth of queue 120 can be user-configurable. There is a tradeoff between the amount of resources being consumed and the ability to perform analysis on the dropped packets. Because queue 120 uses the same shared buffer space as queues of the egress ports, a larger queue 120 can ensure analysis of a greater number of dropped packets but will occupy more buffer space, which may worsen the congestion at the egress ports. Because queue 120 has a limited depth, it can be filled up like any other queue. When queue 120 is full or saturated, the dropped packets can no longer be accepted by internal port 118 and will be discarded. Similar to the egress ports, internal port 118 can have multiple queues, although FIG. 1 only shows a single queue 120. In one example, the multiple queues of internal port 118 can also be priority queues.

Internal port 118 can also be referred to as a “dropped-packet-rerouting port,” because it can reroute or recirculate dropped packets back into switch 100. More specifically, internal port 118 can reroute or recirculate the dropped packets to packet-forwarding logic block 114 to make a second alternative forwarding decision, such as forwarding the dropped packets to a packet-analysis destination (not shown in FIG. 1). Note that, although possible, it is not recommended to re-inject the recirculated packets to the normal data-path flow due to the out-of-order concerns.

In the example shown in FIG. 1, switch 100 includes one internal port. In practice, a switch can also include multiple internal ports. For example, a subset of egress ports can be assigned an individual internal port configured to recirculate packets dropped by that subset of egress ports. However, this can increase the amount of resources (e.g., ports and buffer space) consumed for the purpose of analyzing the dropped packets.

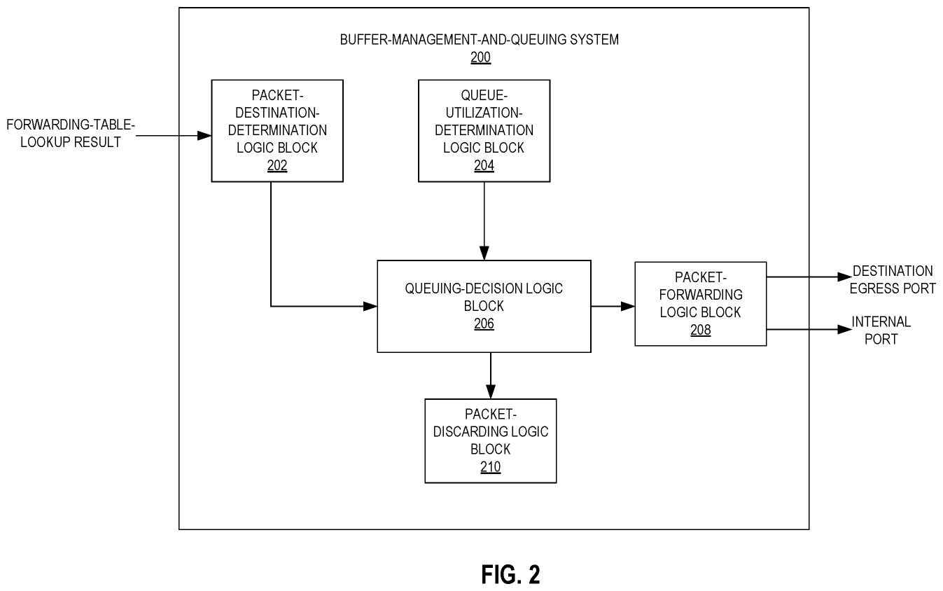

FIG. 2 illustrates a block diagram of a buffer-management-and-queuing system, according to one aspect of the application. In FIG. 2, buffer-management-and-queuing system 200 can include a packet-destination-determination logic block 202, queue-utilization-determination logic block 204, queuing-decision logic block 206, packet-forwarding logic block 208, and packet-discarding logic block 210.

Packet-destination-determination logic block 202 receives, from the packet-forwarding engine, the lookup result of the forwarding tables. The lookup result can indicate the destination port of a received packet. According to one aspect of the application, if the destination port supports multiple queues, packet-destination-determination logic block 202 can further determine the destination queue of the received packet. For example, a destination port may support multiple priority queues, and packet-destination-determination logic block 202 can determine the destination queue based on the priority class of the received packet.

Queue-utilization-determination logic block 204 can be responsible for determining the utilization levels of the queues in the switch. The utilization level of a queue can be determined based on the amount of buffer space currently consumed by the queue and the amount of buffer space allocated to the queue. Depending on the buffer management scheme implemented in the switch, various techniques can be used to determine the utilization level of the queue. According to one aspect of the application, the utilization level of a queue can be determined adaptively based on the overall usage of the buffer. A detailed description of the determination of the adaptive queue utilization can be found in U.S. patent application Ser. No. 17/465,507, Attorney Docket No. 90954661, filed 2, Sep. 2021 and entitled “SYSTEM AND METHOD FOR ADAPTIVE BUFFER MANAGEMENT,” the disclosure of which is incorporated herein by reference in its entirety. Note that in addition to determining the utilization of the queues of the egress ports on the switch, queue-utilization-determination logic block 204 also determines the utilization of queue(s) associated with the internal port that reroutes dropped packets. The utilization of the queue(s) of the internal port can be determined using a similar technique for determining queue utilization of the egress ports.

Queuing-decision logic block 206 can be responsible for making a queuing decision for a received packet (i.e., whether to queue the received packet at a particular queue or to discard the packet). More specifically, queuing-decision logic block 206 needs to make two queuing decisions for the same received packet. The first queuing decision is to decide whether to queue the packet at its destination egress port, or more particularly, in the destination queue, which is determined by packet-destination-determination logic block 202. The second queuing decision is to decide whether to queue the packet at the internal port, or more particularly, in a queue associated with the internal port.

According to one aspect of the application, the two queuing decisions can be made sequentially. Queuing-decision logic block 206 can first decide, based on the utilization of the destination queue of the received packet, whether to queue the packet in the destination queue. If the destination queue still has capacity, queuing-decision logic block 206 then decides to queue the received packet in its destination queue. On the other hand, if the destination queue is saturated (e.g., its utilization reaches a predetermined saturation level), queuing-decision logic block 206 then decides not to queue the received packet in its destination queue. Consequently, the received packet becomes a dropped packet, because it will not reach its intended destination. Note that the saturation level of a queue can be configurable based on the implemented buffer management scheme.

Upon determining not to queue the received packet in its destination queue, queuing-decision logic block 206 can then make a queuing decision on whether to queue the dropped packet in a queue associated with the internal port. This decision can be similarly made based on the queue utilization of the internal port. If its queue is saturated, the internal port has reached its capacity and can no longer accept the dropped packet. Consequently, queuing-decision logic block 206 can decide to discard the dropped packet out of the switch. In such a situation, the dropped packet will not be analyzed. If the internal port still has capacity, queuing-decision logic block 206 can decide to queue the dropped packet in the queue associated with the internal port. This allows the dropped packet to be subsequently recirculated back to the switch by the internal port.

According to an alternative aspect of the application, the two queuing decisions can be made in parallel. In other words, queuing-decision logic block 206 can determine simultaneously whether the destination egress port and the internal port have queuing capacity. Between the queuing decisions, the queuing decision made for the destination egress port takes precedence over the queuing decision made for the internal port. In one example, if the queuing decision made for the destination egress port is a positive decision (meaning that the destination port has capacity), the queuing decision made for the internal port can be ignored. The queuing decision made for the internal port is only considered when the queuing decision made for the destination egress port is a negative decision. When both queuing decisions are negative, the received packet is discarded without further analysis.

In addition to making the queuing decision based on utilization of the individual queues, according to one aspect, queuing-decision logic block 206 can make the queuing decision at a different level of granularity, such as at a sub-queue level, a port level, or a switch level. For example, queuing-decision logic block 206 can make a queuing decision for a packet based on the buffer utilization of the destination port or the buffer utilization of the entire switch.

Packet-forwarding logic block 208 can be responsible for forwarding the packet to a port, which can be an egress port or the internal port, based on the queuing decision made by queuing-decision logic block 206. If queuing-decision logic block 206 decides to queue the packet at a queue associated with the destination egress port, packet-forwarding logic block 208 can forward the packet to the destination egress port. On the other hand, if queuing-decision logic block 206 decides to queue the packet at a queue associated with the internal port, packet-forwarding logic block 208 can forward the packet to the internal port. According to one aspect, to forward the packet to the internal port, queuing-decision logic block 206 can change the packet header to indicate that the destination of the packet is the internal port.

Packet-discarding logic block 210 can be responsible for discarding a received packet when both queuing decisions are negative (i.e., both queues are saturated). Unlike a dropped packet queued at the internal port, once a packet is discarded, it can no longer be circulated back into the switch and cannot be analyzed further. In one example, packet-discarding logic block 210 can include a counter that counts the number of packets being discarded by packet-discarding logic block 210. This counter value can be used by the system administrator to make configuration determinations. For example, if the number of discarded packets increases, the system administrator may increase the buffer space allocated to the internal port.

If a packet is forwarded by packet-forwarding logic block 208 to the destination egress port, the egress port will transmit the packet as normal; if the packet is dropped and forwarded to the internal port, the internal port can recirculate the dropped packet back to the switch. More specifically, the internal port can reroute the packet back to the forwarding engine (e.g., packet-forwarding logic block 114 shown in FIG. 1) to make a packet-forwarding decision on the recirculated packet.

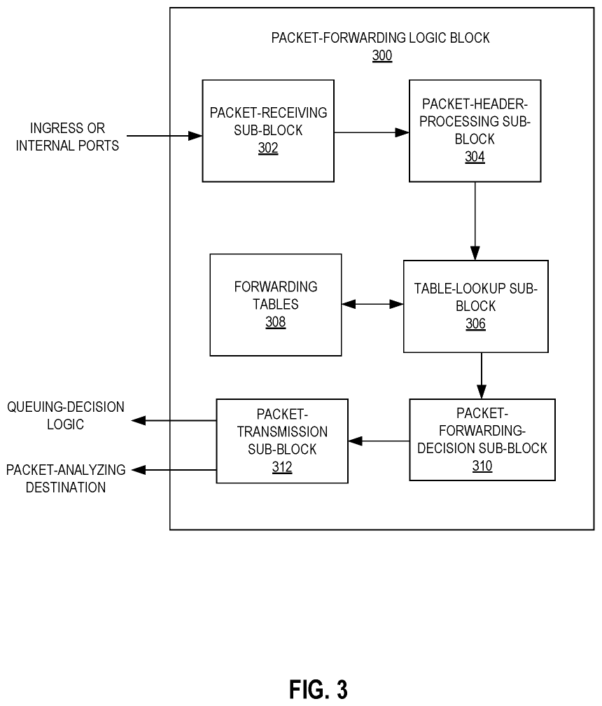

FIG. 3 illustrates a block diagram of a packet-forwarding logic block, according to one aspect of the application. Packet-forwarding logic block 300 can include a packet-receiving sub-block 302, a packet-header-processing sub-block 304, a table-lookup sub-block 306, a number of forwarding tables 308, packet-forwarding-decision sub-block 310, and a packet-transmission sub-block 312.

Packet-receiving sub-block 302 receives packets from the ingress port as well as the internal port. Note that packets received from the internal port are dropped or recirculated packets that have passed through packet-forwarding logic block 300 once.

Packet-header-processing sub-block 304 can process the header information of a received packet. For example, packet-header-processing sub-block 304 can determine the source and/or destination of a received packet based on the packet header. Table-lookup sub-block 306 can be responsible to looking up forwarding tables 308 based on the processed packet header information. Forwarding tables 308 can be configurable and can include an L2 table, an L3 table, and a table that includes one or more user-defined packet-forwarding rules or policies. According to one aspect, the packet-forwarding rules or policies can include a forwarding rule or policy specifically designed to handle the recirculated or rerouted dropped packets. For example, the forwarding rule can indicate that a recirculated packet should be forwarded to a packet-processing destination, instead of an egress port.

Packet-forwarding-decision sub-block 310 can be responsible for making a forwarding decision based on lookup results of forwarding tables 308. There can be multiple table lookup results (e.g., multiple rules or policies) matching a packet. A certain rule or policy may override a different rule or policy. Packet-forwarding-decision sub-block 310 can make a forwarding decision by looking up the various forwarding tables according to a predetermined order. For example, when a packet is received, table-lookup sub-block 306 can look up an L2 forwarding table based on the packet header and determines a destination egress port. Table-lookup sub-block 306 can also determine based on a rule table that the packet is a recirculated packet (because the packet is received from the internal port) and should be sent to an entity capable of analyzing the packet (also referred to as a packet-analyzing destination). The forwarding rule regarding the recirculated packets can override the L2 table lookup. In one example, the forwarding rule table can be looked up first. Once packet-forwarding-decision sub-block 310 determines that a packet is a recirculated packet, it can make a forwarding decision to send the recirculated packet to the packet-analyzing destination, without determining looking up the destination egress port for the packet.

Packet-transmission sub-block 312 can be responsible for transmitting the packet to its destination based on the packet-forwarding decision. For example, if the packet-forwarding decision is to forward the packet to an egress port, packet-transmission sub-block 312 can transmit the packet to the queuing-decision logic to make a queuing decision regarding the egress port and the internal port. If the packet-forwarding decision is to forward the packet to a packet-analyzing destination, packet-transmission sub-block 312 can transmit the packet to the packet-analyzing destination. According to one aspect, the packet-analyzing destination can be the CPU of the switch. More particularly, management software running on the switch CPU can perform analysis on the packet, such as collecting statistics regarding the source, destination, size, or type of the dropped packet. According to another aspect, the packet-analyzing destination can be a network analyzer. The network analyzer can be coupled, locally or remotely, to the switch via a port, also referred to as a network-analyzing port. In one example, the port can be a regular network port on the switch configured to couple to a local or remote network analyzer. When the network analyzer is a local device, the network-analyzing port can be mirrored locally to the network analyzer. When the network analyzer is a remote device (e.g., a remote network analyzer server), the network-analyzing port can be mirrored remotely (e.g., via tunnel encapsulation) to the remote network analyzer.

To implement the disclosed solution in a switch, certain modifications to existing switch hardware can be made. For example, the hardware logic for making the queuing decision can be modified such that it can make two, not just one, queuing decisions for the same packet. Depending on the actual implementation (e.g., whether the queuing decisions are made sequentially or in parallel), different modifications can be used. For example, if the two queuing decisions are made in parallel, the queuing decision hardware logic can include a circuit that allows a positive decision made for the egress port to override any decision made for the internal port. On the other hand, if the two queuing decisions are made sequentially, the queuing decision hardware logic can include a circuit that triggers a queuing decision to be made for the internal port responsive to a negative decision made for the egress port.

As discussed previously, the internal port can be a specifically designed interface (which cannot be found in a current switch), or a regular switch port that is configured to operate in a loopback or recirculation mode. The regular switch port can be configured during the initialization of the switch or it can be configured during the operation of the switch by the management software. For example, in response to the number of dropped packets reaching a threshold, a spare port on the switch can be configured to operate as an internal port to facilitate analysis of the dropped packets. According to one aspect, configuring the internal port can also include allocating buffer space for the internal port. Depending on the system configuration, the buffer space allocated to the internal port can be a fixed amount or a dynamic amount determined based on the traffic load.

In addition to the queuing mechanism and the internal port, other switch components can also be configured to facilitate analysis of the dropped packets. According to one aspect, the forwarding engine needs to be configured to include a dropped-packet rule to state that a packet received from the internal port is a dropped packet and should be forwarded to a predetermined packet-analysis destination. In one example, the dropped-packet rule can specify that the packet-analyzing destination is the switch CPU. In another example, the dropped-packet rule can specify that the packet-analyzing destination is a network analyzer server that is coupled to the switch via a network-analyzing port. The forwarding table can be configured to include the port ID of the network-analyzing port in an entry specific to dropped packets. The configuration of the various switch components can be performed by the control and management software running in the switch CPU. Certain configuration parameters, such as which port can be used as the internal port and the amount of buffer space allocated to the internal port, can be user-configurable.

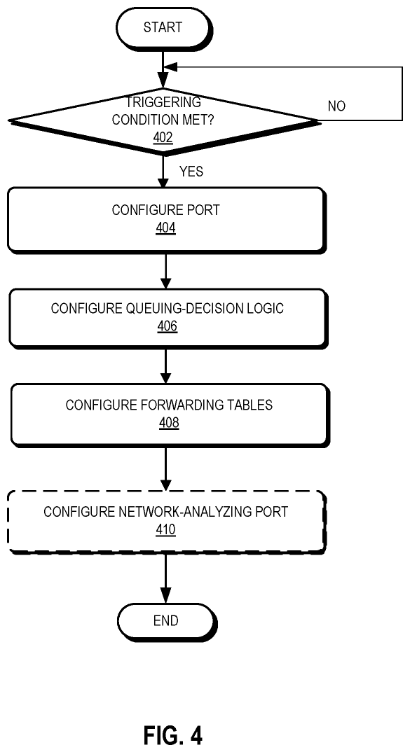

FIG. 4 provides a flowchart illustrating a process for configuring a switch to facilitate analysis of dropped packets, according to one aspect of the application. In this example, the switch has the hardware components that can be used to implement the disclosed solution. However, the port, the queuing mechanism, or the forwarding engine may not yet be configured to recirculate the dropped packets.

During operation, the system can determine whether a triggering condition has been met (operation 402). According to one aspect, the triggering condition can be the number of packets dropped by the switch reaching a predetermined threshold value. Other criteria (e.g., traffic load or need for traffic monitoring) can also be used. Alternatively, the triggering condition can also include receiving a user command. For example, the network administrator may manually turn on the dropped-packet-analysis feature by inputting a command via a control interface. In response to the triggering condition being met, the system can configure the internal port (operation 404). Configuring the internal port can include configuring the port to operate in the packet-loopback mode and allocating buffer space to the port. When operating in the loopback mode, instead of transmitting a packet out of the switch, the port is to recirculate the packet back into the switch. In other words, the same packet will pass the switch twice.

The system also configures the logic for making queuing decisions (operation 406). In one example, the queuing-decision logic can be configured to execute in parallel two distinct queuing decisions for the same packet. In another example, the queuing-decision logic can be configured to sequentially execute the two queuing decisions. More specifically, the queuing decision for the internal port is executed only when the queuing decision for the original egress port returns negative.

The system configures the forwarding tables (operation 408). Configuring the forwarding tables can include adding a rule to specify that a packet received from the internal port is to be forwarded to a predefined packet-analyzing destination, which can be the switch CPU or a network analyzer. If the packet-analyzing destination is the switch CPU, the control and management software can analyze the dropped packet to collect statistics (e.g., source, destination, type, size, etc.) associated with the dropped packet.

The system optionally configures a network-analyzing port that couples a network analyzer to the switch (operation 410). This operation is optional, because if the packet-analyzing destination is the switch CPU, there is no longer the need to configure the network-analyzing port. The network analyzer can be local or remote with respect to the switch. The port traffic can be mirrored locally or remote-mirrored via encapsulation to the network analyzer.

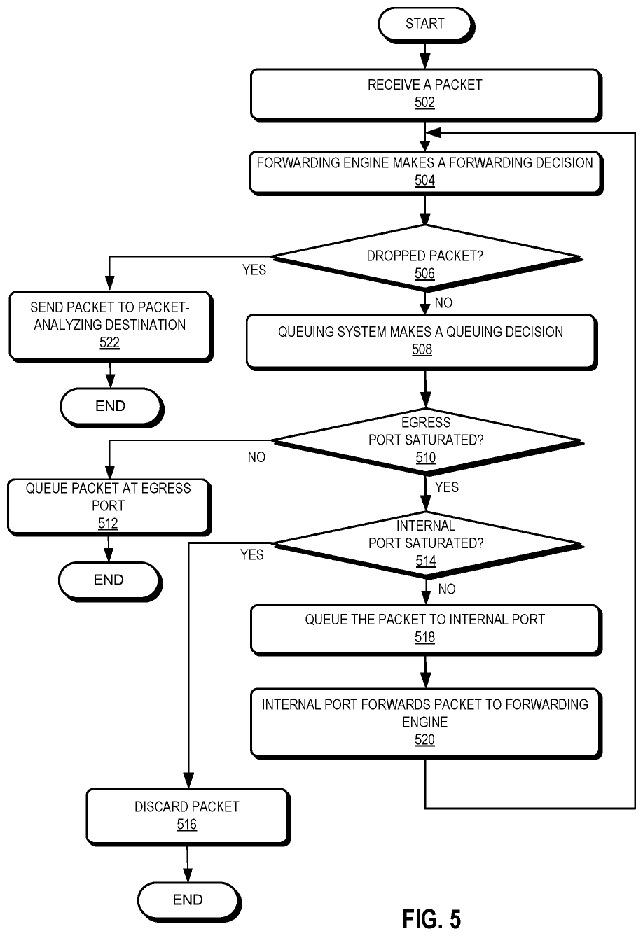

FIG. 5 presents a flowchart illustrating operations for processing a packet by a switch, according to one aspect of the application. During operation, the switch receives a packet (operation 502). In response, the forwarding engine on the switch makes a forwarding decision (operation 504). According to one aspect, the forwarding engine looks up one or more forwarding tables to determine a destination port of the packet. The forwarding engine also determines whether the packet is a dropped (or recirculated) packet (operation 506). In one example, the forwarding engine can determine that a packet received from the internal port is a dropped packet.

If the packet is not a dropped packet, the queuing system of the switch makes a queuing decision (operation 508). More specifically, the queuing decision can be made based on the forwarding decision, which can include a destination egress port of the packet. According to one aspect, the queuing system may first determine whether the destination egress port is saturated (operation 510). Determining whether the destination egress port is saturated can include identifying a queue associated with the packet and determining whether the utilization of the identified queue exceeds a predetermined threshold. In one example, the queue can be identified based on the priority class of the received packet. If the destination egress port is not saturated, the packet is queued at the egress port (operation 512). The packet can later be outputted from the switch by the egress port. If the destination egress port is saturated (the packet is now considered a dropped packet), the queuing system may further determine whether the internal port is saturated (operation 514). If so, the packet is discarded (operation 516) and the process ends. In this situation, the packet leaves the switch without being analyzed.

If the internal port is not saturated, the dropped packet is queued at the internal port (operation 518) and the internal packet can subsequently forward the dropped packet to the forwarding engine (operation 520), thus allowing the forwarding engine to make a forwarding decision (operation 504). If the forwarding engine determines that the packet is a dropped packet, the forwarding engine forwards the packet to a packet-analyzing destination (operation 522) and the process ends.

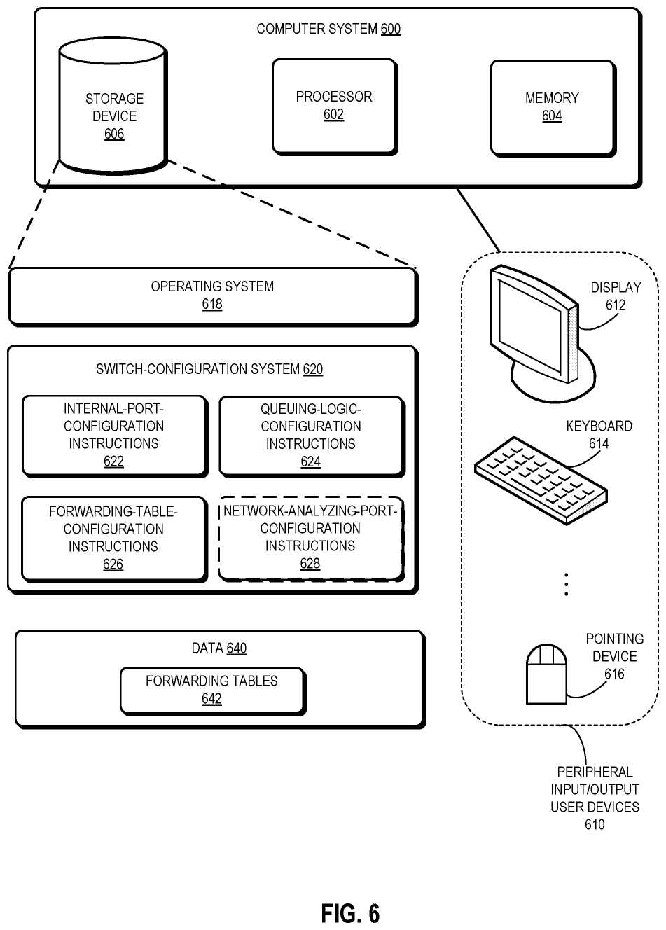

FIG. 6 illustrates a computer system that facilitates processing of dropped packets, according to one aspect of the application. Computer system 600 includes a processor 602, a memory 604, and a storage device 606. Furthermore, computer system 600 can be coupled to peripheral input/output (I/O) user devices 610, e.g., a display device 612, a keyboard 614, and a pointing device 616. Storage device 606 can store an operating system 618, a switch-configuration system 620, and data 640. According to one aspect, computer system 600 can be part of the network switch.

Switch-configuration system 620 can include instructions, which when executed by computer system 600, can cause computer system 600 or processor 602 to perform methods and/or processes described in this disclosure. Specifically, switch-configuration system 620 can include instructions for configuring the internal port for recirculating dropped packets (internal-port-configuration instructions 622), instructions for configuring the queuing logic for making two queuing (either sequentially or in parallel) decisions on each received packet (queuing-logic-configuration instructions 624), instructions for configuring the forwarding tables to ensure that recirculated packets are not treated the same as regular ingress packets (forwarding-table-configuration instructions 626), and optional instructions for configuring the network-analyzing port to ensure that the recirculated packet can be forwarded, via the network-analyzing port, to a local or remote network analyzer (network-analyzing-port-configuration instructions 628).

In general, this disclosure provides a system and method for facilitating analysis of packets dropped by a switch. More specifically, when an ingress packet is dropped due to the egress path of the packet on the switch being out of memory (e.g., when the destination egress port is congested), instead of being ejected out of the switch without further analysis, the dropped packet is sent to a specially configured port internal to the switch, which reroutes the dropped packet back to the switch. To do so, the queuing system of the switch needs to be configured in such a way such that two queuing decisions can be made for the same received packet, one for the original egress port associated with the packet and one for the internal port. The two queuing decisions can be made sequentially or in parallel. The internal port (also referred to as a dropped-packet-rerouting port) sends the dropped packet back to the forwarding engine to make a forwarding decision on the dropped packet. Recognizing that a received packet is a dropped packet (because it is received from the internal port), the forwarding engine forwards the dropped packet to a packet-analyzing entity instead of the original destination egress port associated with the packet. The packet-analyzing entity can be the switch CPU or a network analyzer.

One aspect of the instant application provides a system and method for rerouting dropped packets back to a switch for analysis. During operation, the system determines, by packet-forwarding hardware logic on the switch, a destination port associated with a received packet, and determines whether the destination port is congested. In response to determining that the destination port is congested, the system drops the received packet from the destination port and sends the dropped packet to an internal dropped-packet-rerouting port to reroute the dropped packet back to the packet-forwarding hardware logic. In response to the packet-forwarding hardware logic determining that a packet is a rerouted packet from the internal dropped-packet-rerouting port, the system forwards the rerouted packet to a packet-analyzing entity for analysis.

In a variation on this aspect, the packet-analyzing entity can include at least one of: a central processing unit (CPU) of the switch, a local network analyzer, or a remote network analyzer.

In a further variation, the local or remote network analyzer is coupled to the switch via a network port on the switch.

In a variation on this aspect, the internal dropped-packet-rerouting port can be invisible outside of the switch, and the internal dropped-packet-rerouting port can include a dedicated internal port or a regular switch port configured to operate in a loopback mode.

In a variation on this aspect, sending the dropped packet to the internal dropped-packet-rerouting port can include determining whether a dropped-packet queue associated with the dropped-packet-rerouting port is saturated.

In a variation on this aspect, in response to determining that the dropped-packet queue is not saturated, the system can queue the dropped packet in the dropped-packet queue; and in response to determining that the dropped-packet queue is saturated, the system can discard the dropped packet without analysis of the dropped packet.

In a further variation, determining whether the destination port is congested can include determining whether a destination queue associated with the received packet is saturated, and the system can queue the received packet in the destination queue in response to determining that the destination queue is not saturated.

In a further variation, determining whether the destination queue is saturated and determining whether the dropped-packet queue is saturated can be performed in parallel.

In a variation on this aspect, the system can configure a forwarding table maintained by the packet-forwarding hardware logic to include a packet-forwarding rule that indicates a packet received from the internal dropped-packet-rerouting port is to be forwarded to the packet-analyzing entity.

In a variation on this aspect, in response to determining that a triggering condition is met, the system can configure the internal dropped-packet-rerouting port to allow the internal dropped-packet-rerouting port to reroute the dropped packet back to the packet-forwarding hardware logic.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions have been presented for purposes of illustration and description only. They are not intended to be exhaustive or to limit the scope of this disclosure to the forms disclosed. Accordingly, many modifications and variations will be apparent to practitioners skilled in the art.

What is claimed is:

1. A method, comprising:
determining, by packet-forwarding hardware logic on a switch, a destination port associated with a received packet;
determining whether the destination port is congested;
in response to determining that the destination port is congested, dropping the received packet from the destination port;
sending the dropped packet to an internal dropped-packet-rerouting port to reroute the dropped packet back to the packet-forwarding hardware logic; and
in response to determining, by the packet-forwarding hardware logic, that a packet is a rerouted packet from the internal dropped-packet-rerouting port, forwarding the rerouted packet to a packet-analyzing entity for analysis.

2. The method of claim 1, wherein the packet-analyzing entity comprises at least one of:
a central processing unit (CPU) of the switch;
a local network analyzer; or
a remote network analyzer.

3. The method of claim 2, wherein the local or remote network analyzer is coupled to the switch via a network port on the switch.

4. The method of claim 1, wherein the internal dropped-packet-rerouting port is invisible outside of the switch, and wherein the internal dropped-packet-rerouting port comprises a dedicated internal port or a regular switch port configured to operate in a loopback mode.

5. The method of claim 1, wherein sending the dropped packet to the internal dropped-packet-rerouting port comprises determining whether a dropped-packet queue associated with the dropped-packet-rerouting port is saturated.

6. The method of claim 5, further comprising:
in response to determining that the dropped-packet queue is not saturated, queuing the dropped packet in the dropped-packet queue; and
in response to determining that the dropped-packet queue is saturated, discarding the dropped packet without analysis of the dropped packet.

7. The method of claim 5, wherein determining whether the destination port is congested comprises determining whether a destination queue associated with the received packet is saturated, and wherein the method further comprises queuing the received packet in the destination queue in response to determining that the destination queue is not saturated.

8. The method of claim 7, wherein determining whether the destination queue is saturated and determining whether the dropped-packet queue is saturated are performed in parallel.

9. The method of claim 1, further comprising configuring a forwarding table maintained by the packet-forwarding hardware logic to include a packet-forwarding rule that indicates a packet received from the internal dropped-packet-rerouting port is to be forwarded to the packet-analyzing entity.

10. The method of claim 1, further comprising:
in response to determining that a triggering condition is met, configuring the internal dropped-packet-rerouting port to allow the internal dropped-packet-rerouting port to reroute the dropped packet back to the packet-forwarding hardware logic.

11. A switch, comprising:
a number of ingress ports for receiving packets;
a number of egress ports for transmitting packets;
packet-forwarding hardware logic to determine a destination egress port associated with a received packet;
queuing-decision hardware logic to make a queuing decision on the received packet; and
an internal dropped-packet-rerouting port to reroute a packet dropped from an egress port back to the packet-forwarding hardware logic;
wherein the queuing-decision hardware is to:
in response to determining that the destination egress port is congested, drop the received packet from the destination port; and
send the dropped packet to the internal dropped-packet-rerouting port to reroute the dropped packet back to the packet-forwarding hardware logic; and
wherein the packet-forwarding hardware logic is to, in response to determining that a packet is a rerouted packet from the internal dropped-packet-rerouting port, forward the rerouted packet to a packet-analyzing entity for analysis.

12. The switch of claim 11, wherein the packet-analyzing entity comprises at least one of:
a central processing unit (CPU) of the switch;
a local network analyzer; or
a remote network analyzer.

13. The switch of claim 12, wherein the local or remote network analyzer is coupled to the switch via a network port on the switch.

14. The switch of claim 11, wherein the internal dropped-packet-rerouting port is invisible outside of the switch, and wherein the internal dropped-packet-rerouting port comprises a dedicated internal port or a regular switch port configured to operate in a loopback mode.

15. The switch of claim 11, wherein the queuing-decision hardware is to determine whether a dropped-packet queue associated with the dropped-packet-rerouting port is saturated.

16. The switch of claim 15, wherein the queuing-decision hardware is to:
in response to determining that the dropped-packet queue is not saturated, queue the dropped packet in the dropped-packet queue; and
in response to determining that the dropped-packet queue is saturated, discard the dropped packet without analysis of the dropped packet.

17. The switch of claim 15, wherein, while making a queuing decision on the received packet, the queuing-decision hardware logic is to:
determine whether a destination queue associated with the received packet is saturated; and
queue the received packet in the destination queue in response to determining that the destination queue is not saturated.

18. The switch of claim 17, wherein, while making a queuing decision on the received packet, the queuing-decision hardware logic is to determine, in parallel, whether the destination queue is saturated and whether the dropped-packet queue is saturated.

19. The switch of claim 11, wherein the packet-forwarding hardware logic maintains a forwarding table that includes a packet-forwarding rule indicating that a packet received from the internal dropped-packet-rerouting port is to be forwarded to the packet-analyzing entity.

20. The switch of claim 11, wherein the internal dropped-packet-rerouting port is to reroute the dropped packet back to the packet-forwarding hardware logic in response to determining that a triggering condition is met.
